(19) United States
(12) Patent Application Publication
(10) Pub. No.: US 2016/0344582 A1
(43) Pub. Date: Nov. 24, 2016

(54) CALL HOME CLUSTER

(71) Applicant: HEWLETT PACKARD ENTERPRISE DEVELOPMENT LP, Houston, TX (US)

(72) Inventors: Suhas Shivanna, Bangalore (IN); Mahesh Babu Ramaiah, Bangalore (IN); Dileesh Onniyil, Bangalore (IN)

(21) Appl. No.: 15/110,941

(22) PCT Filed: Jan. 10, 2014
(86) PCT No.: PCT/US14/11034

§ 371 Date: Jul. 11, 2016

(51) Int. Cl. H04L 12/24; H04L 29/08

(52) U.S. Cl. CPC H04L 41/04; H04L 41/0893; H04L 67/303; H04L 67/10

(57) ABSTRACT

In one implementation, a call home system comprises a configuration engine, a cluster engine and an assignment engine. The configuration engine can identify a plurality of potential call home devices. The cluster engine can group a plurality of compute devices into a plurality of clusters. The assignment engine can assign a master call home device to each cluster. In another implementation, a method for calling home can comprise broadcasting a first message, receiving a response from a call home master associated with a cluster, and selecting a group identifier to append to a second message.

### BACKGROUND

Computer systems can be checked for health statuses, state information, configuration information, and other system information. Computer systems can commonly log information about system events, such as system arrows. The logged information and system information can assist in delivering technical support.

### BRIEF DESCRIPTION OF THE DRAWINGS

FIGS. 1 and 2 are block diagrams depicting example call home systems.

FIGS. 3 and 4 depict example environments in which various example call home systems can be implemented.

FIGS. 5-8 are flow diagrams depicting example methods for calling home.

### DETAILED DESCRIPTION

In the following description and figures, some example implementations of call home apparatus, systems, and/or methods are described. An intranet can include a network of compute devices, commonly designated as a local area network (“LAN”). The compute devices can include a system and/or software associated with a system external to the intranet. For example, the compute devices can execute business software having a feedback module and the feedback module can communicate with a backend feedback server at a datacenter. As used herein, the ability to send a message from an intranet device to a backend device is termed “calling home.” A system that supports calling home can send messages to a backend device (discussed herein as a call home destination) regarding events and configuration of a compute device of the system. The call home destination can collect and/or use information from the compute devices of the intranet. For example, support can be remotely provided by receiving messages from the compute devices of the intranet to determine support solutions. A centralized call home solution can monitor service performance and network configuration to initiate an automated service calls for proactive recommendations based on a database of known problems.

Networks can become congested through event messages being sent to backend devices. For example the network can become congested if each device is connected directly to a call home destination. In addition, the call home destination can become overloaded from receiving messages from each device of the LAN. Alternatively, the centralized server can be a single point of failure (and can add to hardware and software maintenance overhead) when devices are connected to the backend service using a centralized server inside the intranet.

Various examples described below relate to calling home based on compute device clusters. By clustering the intranet of compute devices and designating a master call home device from one of the compute devices in a cluster the event and configuration messages from the compute devices of the intranet can be consolidated and sent to the call home destination. Consolidation of these messages can reduce network load and load on the call home destination. Clustering the compute devices can improve connectivity rates which can allow for better initiation of service calls and other proactive recommendations.

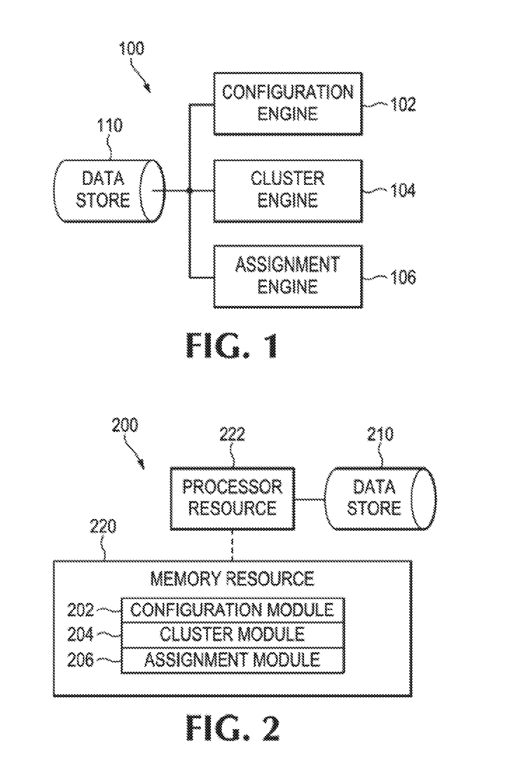

FIGS. 1 and 2 are block diagrams depicting example call home systems. Referring to FIG. 1, an example call home system 100 generally composes a configuration engine 102, a cluster engine 104, and an assignment engine 106. The example call home system 100 can also include a data store 110. The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based only on the stimulus or a combination of stimuli including the stimulus. The term “external” is used below in reference to the intranet of compute devices, such as a private corporate network, where a compute device external to the reference is physically and/or logically located in a different location from the intranet. For example, a LAN of compute devices can be on a private cloud network and the call home destination can be on a public cloud network, where the private cloud network and the public cloud network are located in different geographic locations. For another example, the engines 102, 104, and 106 of the system 100 and the call home destination can be distributed across multiple compute devices and/or located in the same datacenter.

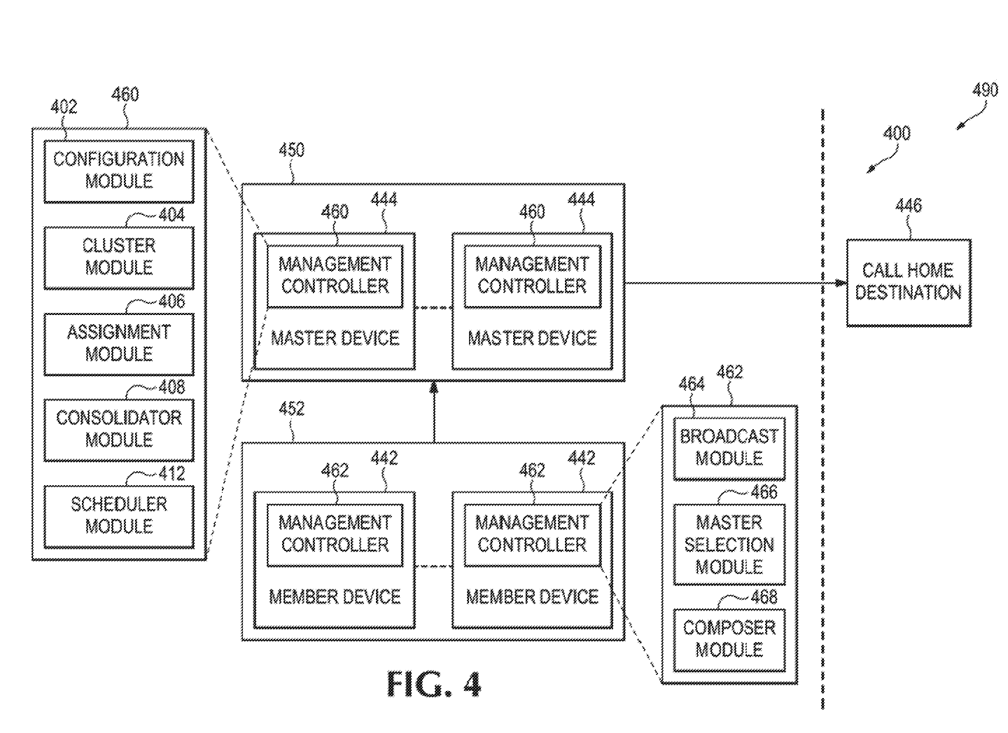

The configuration engine 102 represents any combination of circuitry and executable instructions configured to identify a plurality of potential call home devices. A potential to be a call home master can be identified based on system information of a compute device. A potential call home device is a compute device that configured with a call home configuration. A call home configuration has the capability to communicate with a call home destination, such as an external backend server, for calling home. For example, a device having the call home configuration can have a combination of circuitry and executable instructions to communicate with a call home destination, schedule a message to send to the call home destination, and consolidate messages received from other compute devices. The call home configuration can contain dedicated hardware and/or software to meet connectivity specifications for the calling home service, such as designated by a service level agreement (“SLA”). The call home configuration is discussed in more detail with the description of FIG. 4. The potential of a compute device to qualify as a call home master is described as a “call home configuration potential.” For example, the compute device may have the dedicated hardware to satisfy a call home configuration and have the potential to be a call home master. The call home configuration potential can include a capacity potential, including workload availability, resource utilization, and other system information related to processing potential of a call home master. The call home configuration potential of a compute device can be self-detecting via the system 100, configured using a master-slave setup based on hardware and/or software, or identified based on data received from a user selection interface of the system 100. For another example, all the devices of the network can contain hardware useable to connect to an external server, and a user could manually select a plurality of compute devices to act as potential call home devices via a user interface.

The cluster engine 104 represents any combination of circuitry and executable instructions configured to group a plurality of compute devices into a plurality of clusters. For example, a cluster can be formed for every one hundred compute devices of an intranet. The plurality of clusters can be formed based on information of the plurality of compute devices, such as location or configuration information. The plurality of compute devices can be grouped into a plurality of clusters based on the plurality of call home devices identified by the configuration engine 102. For example, if three potential call home devices are identified, than three clusters of compute devices can be generated.

The cluster engine 104 can group a plurality of compute devices based on a level of homogeneity. For example, a LAN can contain four types of devices, and each device can be grouped into a cluster based on the device type. For another example, compute devices can be grouped based on software installed on the compute device. The level of homogeneity can be based on data from the compute device and/or messages sent from the compute device. For example, the configuration messages sent from a plurality of compute devices can be similar and grouped together. The level of homogeneity can be set based on a user selection or a granularity policy. For example, the configuration of each compute device can be slightly different, but can be grouped based on at least one element similar across compute devices of a cluster. The cluster engine 104 can ascertain a level of homogeneity of the plurality of compute devices. For example, the system information of each compute device can be collected and similar configurations and machine states can be grouped together. The level of homogeneity can be based on system information associated with the plurality of compute devices. In particular, the level of homogeneity can be based on configuration information, such as a version of operating system (“OS”). The system information can include state information (such as utilization, latency, connection rate, uptime, etc.) and configuration information (such as installed software and OS information, hardware and peripheral information, firmware information, network information, SLA information etc.)

The cluster engine 104 can group (automatically or on-demand) the compute devices based on homogeneity or group the plurality of compute devices based on a manual configuration selectable by a user. The level of homogeneity can be detected using a message digest computed on the configuration information, such as a hash computed on the fields of a configuration data packet. For example, the message digest can be a number based on a hash operation that uses the configuration information as input. The configuration data packet is a network message that contains the configuration information of the compute device.

The assignment engine 106 represents any combination of circuitry and executable instructions configured to assign a master device to each cluster. For example, each cluster of the plurality of clusters grouped by the cluster engine 104 can be assigned a master device to manage calling home for the cluster. The master device (also discussed herein as “master call home device” and “call home master”) is a compute device designated as the point of contact for the compute devices of the cluster to communicate with the call home destination. For example, the compute devices can be assigned a cluster identifier associated with the compute device designated as the call home master for the cluster. The call home master can be a virtual machine or software configured to communicate with the call home destination. A compute device having a potential call home configuration can be designated as the master device. For example, the master device can be selected from the compute devices of the cluster rather than a separate device available for sending data to the call home destination. The designated compute device can be configured as a call home master, or otherwise appointed as call home master, to communicate with a call home destination. The compute devices of the system 100, including the call home master, can communicate via a management LAN interface or a system LAN interface. The management and or system interface can be used to propagate the call home master address and/or cluster identifier to the compute devices of the cluster associated with the master device. The call home master can be configured to send a system message to a call home destination outside the intranet.

The assignment engine 106 can perform actions for redundancy and/or dynamic operations to ensure continued communication with the call home destination. For example, the assignment engine 106 can perform at least one of assign a secondary master device to a cluster and reassign a master device based on performance data and load within the cluster. The performance data and load data can include latency statistics, bandwidth, user statistics, system event messages, etc.

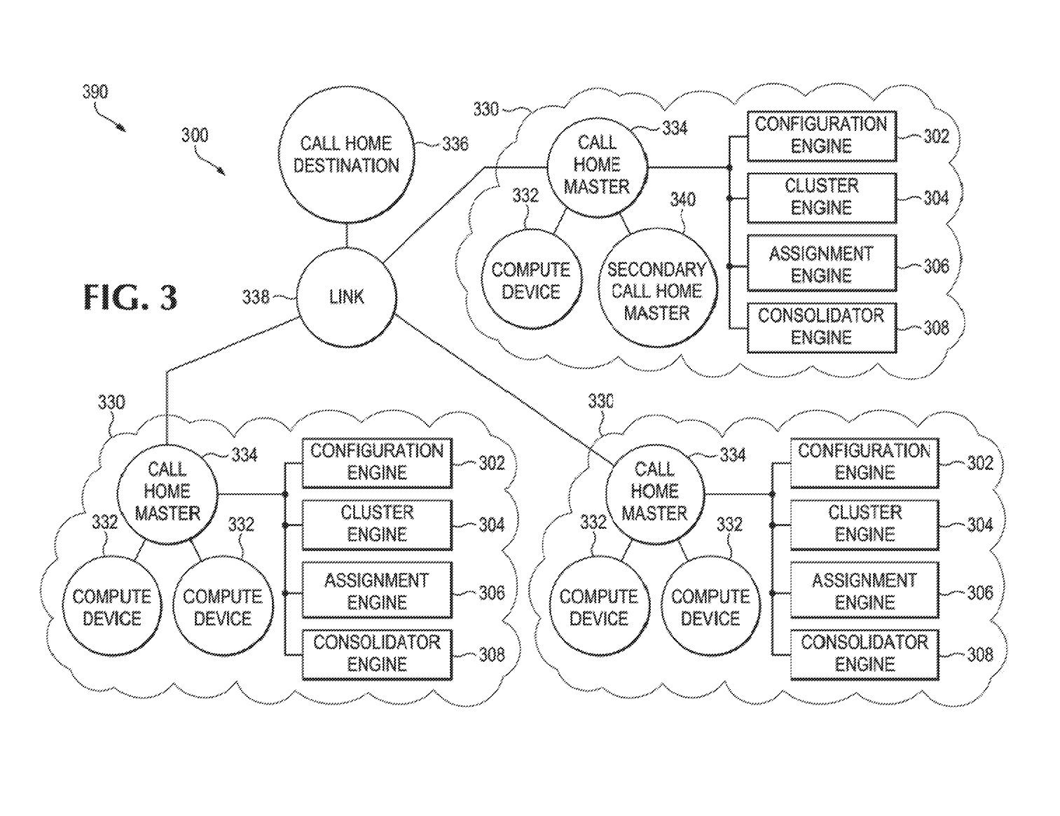

The master device can send a system message to a call home destination, such as an external backend server. The master device can maintain the credentials to connect with the call home destination. All other servers will communicate with the call home destination using the call home master. For example, the master device acts as a proxy to connect data of the compute devices to the call home destination. The call home master can consolidate the messages from the other servers of the cluster as described in more detail in the description of the consolidates engine 303 of FIG. 3. For example, instead of each of the compute devices of the cluster sending the same configuration information to the call home destination, the call home master can send a single message with the configuration information and the list of compute devices associated with that configuration information.

The data store 110 can store data used by or otherwise associated with the system 100. Specifically, the data store 110 can store data used or produced by the configuration engine 102, the cluster engine 104, and the assignment engine 106. For example, the data store 110 can include data associated with the system 100, such as cluster identification information, state information, configuration information, a call home configuration, a message, a message digest, etc.

FIG. 2 depicts the example call home system 200 can be implemented on a memory resource 220 operatively coupled to a processor resource 222. The processor resource 222 can be operatively coupled to a data store 210. The data store 210 can be the same as the data store 110 of FIG. 1. The data store 210 can be accessible by the modules 202, 204, 206, and other modules of the system 200 to maintain data associated with the system 200.

Referring to FIG. 2, the memory resource 220 can contain a set of instructions that can be executable by the processor resource 222. The set of instructions can implement the system 200 when executed by the processor resource 222. The set of instructions stored on the memory resource 220 can be represented as a configuration module 202, a cluster module 204, and an assignment module 206. The processor resource 222 can carry out the set of instructions to execute the configuration module 202, the cluster module 204, the assignment module 206, and/or any appropriate operations among or associated with the modules of the system 200. For example, the processor resource 222 can carry out a set of instructions to receive system information from a plurality of compute devices, maintain a cluster based on the system information, select a call home master of the cluster, and compose a message to send to a call home destination. The configuration module 202, the cluster module 204, and the assignment module 206 represent program instructions that when executed function as the configuration engine 102, the cluster engine 104, the assignment engine 106 of FIG. 1, respectively.

The processor resource 222 can be one or multiple central processing units (“CPU”) capable of retrieving instructions from the memory resource 220 and executing those instructions. The processor resource 222 can process the instructions serially, concurrently, or in partial concurrence, unless described otherwise herein.

The memory resource 220 and the data store 210 represent a medium to store data utilized by the system 200. The medium can be any non-transitory medium or combination of non-transitory mediums able to electronically store data and/or capable of storing the modules of the system 200 and/or data used by the system 200. For example, the medium can be a storage medium, which is distinct from a transmission medium, such as a signal. The medium can be machine readable, such as computer readable. The data of the data store 210 can include representations of data and/or information mentioned herein, such as cluster information and system information.

In the discussion herein, the engines 102, 104, and 106 of FIG. 1 and the modules 202, 204, and 206 of FIG. 2 have been described as a combination of circuitry and executable instructions. Such components can be implemented in a number of fashions. Looking at FIG. 2, the executable instructions can be processor executable instructions, such as program instructions, stored on the memory resource 220, which is a tangible, non-transitory computer readable storage medium, and the circuitry can be electronic circuitry, such as processor resource 222, for executing those instructions. The processor resource 222, for example, can include one or multiple processors. Such multiple processors can be integrated in a single device or distributed across devices. The memory resource 220 can be said to store program instructions that when executed by the processor resource 222 implements the system 200 in FIG. 2. The memory resource 220 can be integrated in the same device as the processor resource 222 or if can be separate but accessible to that device and the processor resource 222. The memory resource 220 can be distributed across devices. The memory resource 220 and the data store 210 can represent the same physical medium unless otherwise described herein.

In one example, the executable instructions can be part of an installation package that when installed can be executed by processor resource 222 to implement the system 200. In that example, the memory resource 220 can be a portable medium such as a CD, a DVD, a flash drive, or memory maintained by a computer device, such as server device 392 of FIG. 3, from which the installation package can be downloaded and installed. In another example, the executable instructions can be part of an application or applications already installed. Here, the memory resource 220 can include integrated memory such as a hard drive, solid state drive, or the like.

FIGS. 3 and 4 depict example environments in which various example call home systems can be implemented. Referring to FIG. 3, the example environment 390 is shown to include an example call home system 300. As discussed further below, the example environment 390 of FIG. 3 depicts the system 300 distributed across call home masters 334 of each cluster and connected to a call home destination 336 via a link 338 between the call home destination 336 and the call home masters 334. The call home masters 334 can be the same as the compute devices 332 except for the characteristic that the call home masters 334 have been designated as communication intermediaries between the compute devices 332 of the cluster 330 and the call home destination 336. The system 300 (described herein with respect to FIGS. 1 and 2) can represent generally any combination of circuitry and executable instructions configured to call home based on clusters. The system 300 can include a configuration engine 302, a cluster engine 304, and an assignment engine 306 that are the same as the configuration engine 102, the cluster engine 104, and the assignment engine 106 of FIG. 1, respectively, and for brevity, the associated descriptions are not repeated.

The example system 300 of FIG. 3 shows a cluster having a secondary call home master 340. The assignment engine 306 can assign a secondary call home master 340 to assist, distribute, replace, or otherwise perform as the call home master 334 in communications with the call home destination 336 or other operations performed by the call home master 334. Any number of clusters 330 can include a secondary call home master 340. Each cluster 330 can include any number of secondary call home masters 340.

The example system 300 of FIG. 3 also includes a consolidator engine 308. The consolidator engine 308 represents any combination of circuitry and executable instructions configured to combine the system information and reduce duplicative data. For example, a set of configuration information from a plurality of compute devices 332 can be aggregated by the consolidator engine 308 and the duplicative configurative information can be removed by the consolidator engine 308. The messages sent from the call home master 334 can be consolidated by the consolidator engine 308. For example, the configuration information of the cluster 330 can be de-duplicated by removing the repetitive information of the messages from the compute devices 332 of the cluster 330 and listing the variable information of the messages from the compute devices 332 of the cluster 330. The messages from the cluster (and network traffic) can be reduced in size and/or amount when duplicative system information is removed and/or otherwise reduced. The consolidator engine 308 can consolidate information based on homogeneity of the system information. For example, the messages may not be exactly the same and can be consolidated based on the degree of similarity among the messages.

System information can include data requested for periodic collection by the call home destination 336, such as configuration information including hardware, firmware, and/or OS inventory data. This information can be static and the same across homogenous servers. The call home master 334 can consolidate the data and utilize a group identifier, such as a cluster identifier, and unique identifiers for each compute device 332, such as a serial number and/or a universally unique identifier. For example, if fifteen servers are running the same version of a current OS and five servers are running an older version of the OS, the call home master 334 can send a message (or a few messages having the cluster identifier) listing the serial numbers of the servers running the updated OS and listing the serial numbers of the servers running the older OS. In that example, the traffic between the call home destination 336 and the cluster of servers can be reduced from twenty messages (e.g. if every server sent a configuration message to the call home destination 336) to a single message sent from the call home master 334.

The system information from the compute devices of a cluster 330 can be consolidated based on a policy to determine the category of data to be sent (or not sent) and a level of granularity. For example, a user could select to send only hardware related information and request the information to be de-duplicated as much as possible. The level of granularity can be the level of consolidation, such as the level of de-duplication of the system information. The consolidation policy can be based on at least one of a response time and a customer support contract. Consolidation of data can also reduce the load on the call home destination 336 to maintain reduced sets of customer data in comparison to database systems without using the systems and methods described herein.

The engines 302, 304, 306, and 308 can be embedded in a controller or other management engine, such as a combination of circuitry or executable instructions to manage the compute devices 332 of the system 300, as discussed in more detail in FIG. 4. For example, the call home configuration discussed in the description of FIG. 1 can include a data consolidator embedded into a controller. For another example, the engines 302, 304, 306, and 308 can be embedded in an OS application inside a compute node.

The example environment is a clustered environment that shows compute devices 332 in three clusters 330. Each cluster 330 has a compute device 332 designated as a call home master 334. Each compute device 332 is able to communicate with the call home destination 336 via a call home master 334 of a cluster 330. For example, the compute device 332 can communicate a system event to the call home destination 336 by sending the system event to the call home master 334.

The example system 300 of FIG. 3 is shown as distributed across call home masters 334. For example, the call home master 334 can communicate to establish the clusters 330 and assign compute devices 332 to clusters accordingly. The example system 300 can be integrated into a compute device 332, call home master 334, call home destination 336, or distributed across any combination of compute devices 332, 334, and 336. The environment 330 can include a cloud computing environment. For example, any appropriate combination of the system 300 and compute devices 332, 334, and 336 can be a virtual instance and/or can reside and/or execute on a virtual shared pool of resources described as a “cloud.” The environment 300 can include any number of clouds.

In the example of FIG. 3, a first compute device 332 can communicate with a second compute device designated as a call home master 334. A compute device represents generally any device capable of computing and configured to respond to a network request received from another compute device. A compute device 332 can include a webserver, an application server, or a data server, for example. A call home master 334 represents generally any computing device configured with a call home configuration to communicate a request and receive and/or process the corresponding messages in preparation to send a message to the call home destination 336. A link 338 represents generally one or any combination of a cable, wireless, fiber optic, or remote connections via a telecommunications link, an infrared link, a radio frequency link or any other connectors of systems that provide electronic communication. The link 338 can include, at least in part, intranet, the Internet, or a combination of both. The link 338 can also include intermediate proxies, routers, switches, load balancers, and the like.

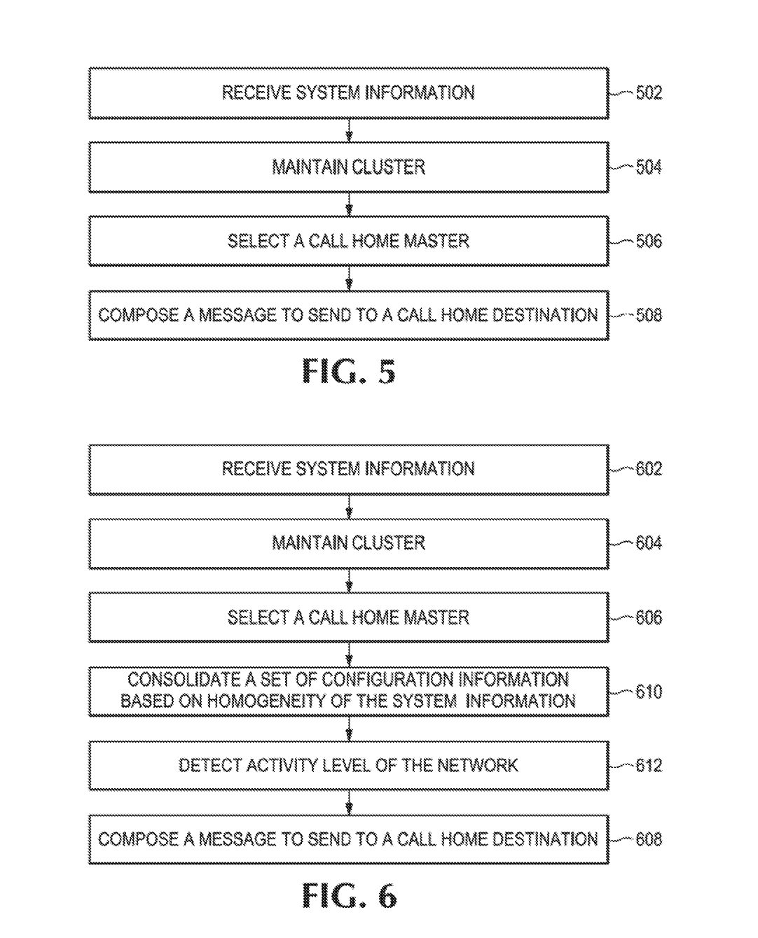

Referring to FIGS. 1-3, the engines 102, 104, and 106 of FIG. 1 and/or the modules 202, 204, and 206 of FIG. 2 (represented as modules 302, 304, and 306 of FIG. 3) can be distributed across compute devices 332 (including call home masters 334 and/or the call home destination 336), other devices or storage mediums, or a combination thereof. The engines and/or modules can complete or assist completion of operations performed in describing another engine and/or module. For example, the cluster module 304 of FIG. 3 can request and/or complete the operations and/or perform the methods of the cluster module 304 as well as the configuration module 302, the assignment module 306, and the consolidator module 308. The engines and/or modules can perform the example methods described in connection with FIGS. 5-8.

FIG. 4 depicts an example environment 490 in which various example call home systems can be implemented. Referring to FIG. 4, the example environment 490 depicts a group 450 of compute devices designated as master devices 444 and a group 452 of compute devices not designated as call home masters, discussed herein as member devices 442. The compute devices of group 450 can be configured the same as the computed devices of group 452. In other words, the compute devices of groups 450 and 452 can each have the potential to be a call home master, and the groups 450 and 452 can be dynamically arranged where the compute devices can be designated as a master device or a member device at any given time as determined by the system 400 and/or a user. Each member device 442 can be associated with a cluster and/or a master device 444 of the call home masters group 450. In general, the group 452 of member devices 442 communicates with the call home destination 446 via the group 450 of master devices 444. The member devices 442 can be logically or physically connected to the master devices 444. The master devices 444 of the system 400 include a first management controller 460. The member devices 442 of the system 400 include a second management controller 462. The first management controller 460 and the second management controller 462 represent circuitry, executable instructions, or a combination of circuitry and executable instructions to manage the system 400. For example, the management controllers 460 and 462 can be software (such as an OS), hardware (such as a network interface controller), or a combination of software and hardware.

The compute devices of the call home master group 450 can execute modules that implement the system 400 via a first management controller 460. A master device 440 can include a configuration module 402, a cluster module 404, and an assignment module 406 that are the same as the configuration module 202, the cluster module 204, and the assignment module 206. The configuration module 402 can receive system information, such as configuration information, from a plurality of compute devices, such as compute devices of the call home master group 450 and the non-call home master group 452. The cluster module 404 can maintain a cluster of compute devices based on the system information received by the configuration module 402. For example, the system information of the compute devices can provide the potential call home configuration of the plurality of compute devices in the call home master group. The assignment module 406 can select a master device 444 and assign the master device 444 to a cluster of the plurality of member 442 of the non-call home master group 452. The assigned call home master 444 can compose a message associated with a member device 442 of the cluster to send to a call home destination 446.

The master device 444 can have a consolidator module 408 to consolidate a set of configuration information based on homogeneity of the system information before composing and sending the message. The consolidator module 408 can represent program instructions that when executed function as a consolidator engine 308 of FIG. 3. The master device 444 can include a schedule module 412. The schedule module 412 represents program instructions that when executed by a processor resource function as a combination of circuitry and executable instructions to schedule message delivery to the call home destination 446. For example, the master device 444 can schedule messages to delivery at certain times and/or based on a policy, such as sending messages at times based on urgency and activity level of the network.

The master device 444 can determine the message is urgent based on a system event received from one of the member devices 442 of the cluster assigned to the master device 444. The master device 444 can send the message to the call home destination 446 based on a level of urgency of the system event. For example, the master device 444 can immediately send a message regarding a critical system event and wait a time period to receive possible further event messages when the system event has a priority level lower than critical.

The master device 444 can defect an activity level of the network and transmit the message at a time based on the activity level. The master device 444 can be aware of the traffic between the call home destination 446 and the intranet (and/or the load on the intranet) and determine to wait to send a message of consolidated configuration information when the activity level achieves a low enough threshold to communicate with the call home destination 446 while concurrently meeting the specification of the support contract and/or network state operation levels.

The member devices 442 of the non-call home master group 452 can execute modules to implement the system 400 via a second management controller 402. For example, the second management controller 462 can include a broadcast module 464, a master selection module 466, and a composer module 468. The broadcast module 464 represents program instructions that when executed implement a combination of circuitry and executable instructions to broadcast a discovery message to find a call home master 444. For example, a member device 442 can broadcast a discovery message, such as registration data, to find s master device 444. A master device 444 can receive the discovery message from a member device and send a reply message to alert the member device 442 of the existence of the master device 444. The reply message can include master system information such as call home configuration information, capacity information, and latency information.

The master selection module 466 represents program instructions that when executed by a processor resource implement a combination of circuitry and executable instructions to select a call home master 444. For example, the member device 442 can receive information and select a master device 444 to send messages to when communicating with the call home destination 446. The member device 442 can assign itself to a cluster (or be assigned by a master device 444) based on the master system information of the second message. For example, the member device 442 may receive multiple reply messages, ascertain which cluster is optimal for joining, and select a group identifier to append to a call home message associated with the ascertained cluster. The group identifier can be appended to the call home message by placing the group identifier in the message or otherwise associating the identifier with the message, such as placing the identifier in a network packet header associated with the message.

As mentioned, the member device 442 can receive a second response from a second master device 444 or multiple responses from multiple call home masters 444. The member device 442 can use the responses from each call home master 444 to determine which call home master 444 to select for communication with the call home destination 446. The master selection module 466 can select a call home master 444 based on a selection policy. The selection policy defines a set of conditions and/or priorities in determining which call home master 444 to assign to the member device 442. For example, the selection policy can determine the call home master 444 with a response time that achieves a threshold can be selected over a call home master 444 that does not achieve the threshold. The selection policy can be based on at least one of a response time, a device load, a number of compute devices of the cluster, a latency, a data category, a data granularity, and a customer support contract.

The composer module 468 represents program instructions that when executed by a processor resource implement a combination of circuitry and executable instructions to compose a message to the call home master 444. For example, a system event can occur on the member device and the composer module 468 can compose a message regarding the system event to send to the master device 444 to forward onto the call home destination 446, consolidating the message based on urgency of the system event. For static configuration information, the composer module 468 can generate a schedule time value based on a unique serial number of the member device 442 and send the system information based on the schedule time value. For example, the system information can include state information and a configuration information that, if sent at schedule time value different from a schedule time value of another compute device, can allow the network load to be balanced over time rather than having all compute devices send system information at the same time. For another example, each member device 442 can send messages based on a random time value generated using a unique serial number, a universally unique identifier, and a current uptime associated with the compute device. Based on a configurable message schedule and network load awareness, data packets can be sent out at predetermined or dynamic times, to the call borne destination 446 in a manner to distribute traffic over a time period, such as a twenty four hour period, and limit traffic on the management network at a particular time, especially peak traffic times.

FIGS. 5-8 are flow diagrams depicting example methods for calling home. Referring to FIG. 5, example methods for calling home can generally comprise receiving system information, maintaining a cluster, selecting a call home master of the cluster, and composing a message to send to a call home destination.

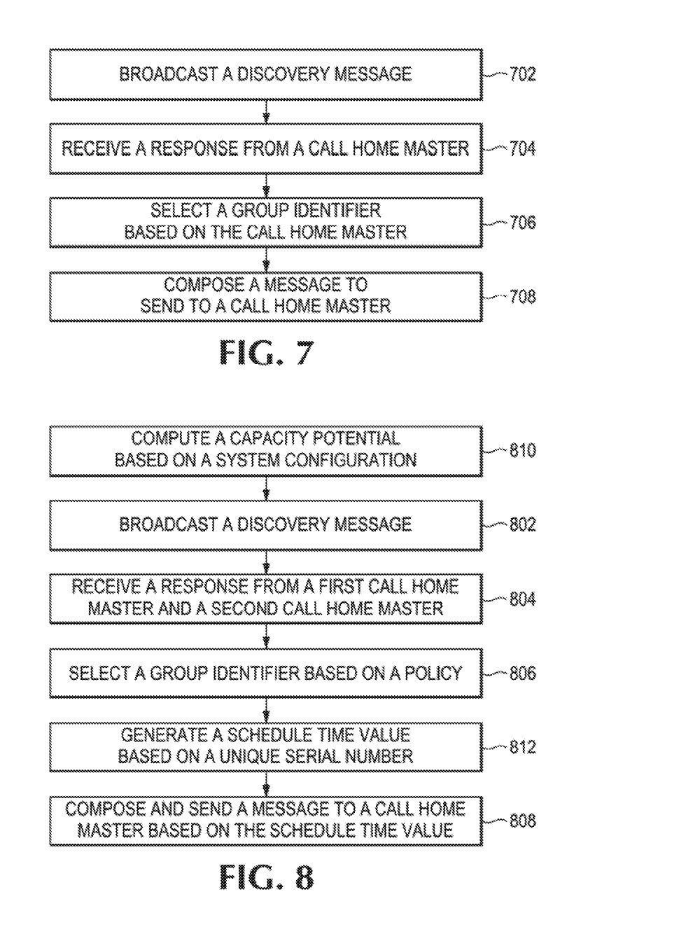

At block 502, system information is received from a plurality of compute devices. For example, system information including configuration information can be received from a plurality of compute devices providing a service to be monitored by a call home destination. The system information can include the capacity potential of the compute device, such as whether the device is configured to be a call home master, as discussed in more detail in the description associated with FIG. 7.

At block 504, a cluster is maintained based on the system information from the plurality of compute devices. For example, a cluster can be a plurality of homogenous compute devices. The system information can be used to determine which compute devices of the plurality of compute devices can be designated as a call home master. At block 506, a call home master is selected for the cluster. For example, one of the compute devices can be selected and appointee as the call home master to communicate with the call home destination on behalf of the plurality of compute devices of the cluster. The call home master can compose and send a message to a call home destination at block 508. For example, the call home master can periodically compose data configuration messages associated with the configuration information of the plurality of compute devices of the cluster and send the configuration messages to the call home destination based on a schedule. At block 508, a message is composed to send to a call home destination.

FIG. 6 includes blocks similar to blocks of FIG. 5 and provides additional blocks and details. In particular, FIG. 6 depicts additional blocks and details generally regarding consolidating configuration information and detecting an activity level of the network. The blocks 602, 604, 606, and 608 are similar to blocks 502, 504, 506, and 508 of FIG. 5, respectively, and, for brevity, the associated descriptions are hot repeated.

At block 610, a set of configuration information is consolidated. The call home master can consolidate the information received form the plurality of compute devices of the cluster to compose a message to send to the call home destination. The set of configuration information can be consolidated cased on homogeneity of the system information. For example, the plurality of compute devices can be clustered into a group having homogenous configuration information and the messages from the plurality of compute devices can be consolidated accordingly.

At block 612, an activity level of the network is defected. For example, the call home master can detect the activity level using a monitor, event messaging system, or other mechanism for determining the activity level of the network. The activity level of the network can be used in determining when to send cell home messages over the network. For example, the call home messages can be saved for non-peak use times of the network, unless the message is urgent.

At block 608, a message is composed and sent to a call home destination based on the consolidation of configuration information at block 610 and the activity level detected at block 612. For example, the message sent to a call home destination can contain the consolidated configuration information and the message can wait to be sent during an activity level that can handle the additional load of sending the message to the call home destination.

FIGS. 7 and 8 represent example methods for calling home from the perspective of a compute device to be assigned a cluster, such as a compute device that has been added to the LAN. Referring to FIG. 7, example methods for calling home can generally comprise broadcasting a discovery message, receiving a response from a call home master, and selecting a group identifier.

At block 702, a discovery message is broadcasted. A compute device can broadcast a discovery message to find a call home master. The message can be broadcasted to the entire network when the compute device inventories the network for call home masters. The broadcast message can be sent via a management LAN or system LAN to a plurality of compute devices of the intranet.

At block 704, a response is received from a call home master. For example, a call home master can be configured to respond to a discovery message and supply information to be used in determining which call home master should be selected as the intermediary of the compute device and the call home destination. A single discovery message can receive multiple call home master responses that can be from different clusters.

At block 706, a group identifier is selected based on the call home master. the group identifier can be associated with the cluster and/or the call home master selected based on the responses to the discovery message. The selection of the group identifier can be based on a selection policy. For example, the compute device can determine which call home master fits the selection policy. The selection policy can be based on at least one of a response time, a device load, a number of compute devices of the cluster a latency, a data category, a data granularity, and a customer support contract. For example, the compute device can select the group identifier associated with the call home master with the lowest device load provided in the responses.

At block 708, a message is composed to send to the call home master. The compute device can compose a message of system information to be sent to the call home master.

FIG. 8 induces blocks similar to blocks of FIG. 7 and provides additional blocks and details. In particular, FIG. 8 depicts additional blocks and details generally regarding computing a capacity potential and generating a schedule time value. The blocks 802, 804, 806, and 808 are similar to blocks 702, 704, 706, and 708 of FIG. 7, respectively, and, for brevity, the associated descriptions are not repeated.

At block 810, a capacity potential is computed based on a system configuration. The capacity potential represents the potential capabilities of a compute device based on system information. For example, the capacity potential can include system information, such as potential can home configuration information and state information, and the system information can be used to determine operational statistics of the compute device. The capacity potential can be used to determine whether a compute device can be appointed as a call home master. For example, a compute device added to the system may have greater capacity potential to act as a call home master than the currently appointed master device. The capacity potential can be sent to the call home system, such as a configuration module executing on a currently appointed call home master of the call home system. For example, a broadcast module, such as broadcast module 464 of FIG. 4, can determine the capacity potential satisfies a call home configuration, calculate available workload and bandwidth potential, and send the capacity potential (as well as other information) to the call home system, such as system 100 of FIG. 1, to determine if the compute device is to be used as a call home master. A broadcast module can communicate with the call home system, such as via a call home master, and the modules of the call home system, such as an assignment engine, can assign the compute device as a call home master (or secondary call home master.) For example, the configuration engine, such as configuration engine 102, can determine the added compute device has a call home configuration potential and inform a cluster engine and an assignment engine, such as cluster engine 104 and assignment engine 106 of FIG. 1, to reassign the call home master of the cluster or create a cluster and assign the added compute device as the call home master for that cluster.

At block 812, a schedule time value is generated based on a unique serial number of the compute device. The schedule time value can be different for each compute device to distribute the network load over a time period. For example, the unique serial number can provide variety to the times scheduled by each compute device. Messages can be scheduled to send based on a random time, manually, or dynamically, to assist the network load and satisfy the conditions of a customer support contract. The message can be composed and/or sent to a call home master based on the schedule time value at block 808.

Although the flow diagrams of FIGS. 4-8 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

The present description has been shown and described with reference to the foregoing examples. It is understood, however, that other forms, details, and examples may be made without departing from the spirit and scope of the invention that is defined in the following claims.

What is claimed is:

1. A call home system comprising:
a configuration engine to identify a plurality of potential call home devices based on system information, the potential call home devices having a call home configuration;
a cluster engine to group a plurality of compute devices into a plurality of clusters based on the plurality of potential call home devices; and
an assignment engine to assign a master device to each cluster, the master device to send a system message to a call home destination.

2. The call home system of claim 1, comprising:
a consolidator engine to combine the system information and reduce duplicative data, the call home configuration to include a consolidator engine embedded into a controller.

3. The call home system of claim 1, wherein the cluster engine is to:
ascertain a level of homogeneity of the plurality of compute devices, the level of homogeneity based on system information, the system information to include state information and configuration information; and
group a plurality of compute devices based on the level of homogeneity.

4. The call home system of claim 3, wherein the cluster engine is to:
group the plurality of compute devices based on at least one of:
a user cluster selection; and
the level of homogeneity, the level of homogeneity to be detected using a message digest computed on the configuration information of a configuration data packet.

5. The call home system of claim 1, wherein the assignment engine is to perform at least one of:
assign a secondary master device to a cluster; and
reassign the master device based on performance data end load data within the cluster.

6. A machine readable storage medium comprising a set of instructions executable by a processor resource to:
receive system information from a plurality of compute devices;
maintain a cluster based on the system information;
select a master device of the cluster based on the system information; and
compose a message to send to a call home destination.

7. The medium of claim 6, wherein the set of instructions is to:
determine the message is urgent based on a system event; and
send, from the master device, the message to the call home destination based on a level of urgency of the system event.

8. The medium of claim 6, wherein the set of instructions is to:
consolidate a set of configuration information based on homogeneity of the system information.

9. The medium of claim 8, wherein the set of instructions is to:
detect an activity level of the network; and
transmit the message at a time based on the activity level.

10. The medium of claim 6, wherein the set of instructions is to:
receive a first message including registration data to discover a compute device designated as a master device from a compute device;
send a second message to alert the compute device of the master device, the second message having master system information including call home configuration information, capacity information, and latency information; and
assign the compete device to a cluster based on the master system information of the second message.

11. A method for calling home comprising:
broadcasting a first message to find a master device, the master device configured to send a second message to a call home destination outside the intranet;
receive a response from the master device associated with a cluster, the cluster to contain a plurality of compute devices; and
selecting a group identifier, based on the master device, to append to a third message, the group identifier associated with the cluster.

12. The method of claim 11, comprising:
receiving a second response from a second master device; and
selecting the first master device based on a policy, the policy to define a set of conditions and a set of priorities.

13. The method of claim 12, wherein the policy is based on at least one of:
a response time, a device load, a number of compute devices of the cluster, a latency, a data category, a data granularity, and a customer support contract.

14. The method of claim 11, comprising:
generating a schedule time value based on a unique serial number; and
sending system information based on the schedule time value to balance a network load, the system information to include state information and configuration information.

15. The method of claim 11, comprising
computing a capacity potential based on a system configuration; and
sending a call home configuration potential when the system configuration satisfies a call home configuration, the call home configuration potential to include the capacity potential.
